(19) United States
(12) Patent Application Publication
(10) Pub. No.: US 2022/0212757 A1
(43) Pub. Date: Jul. 7, 2022

(54) HIGH PERFORMANCE COMPOSITES FOR UNDERWATER APPLICATIONS

(71) Applicant: Raytheon Company, Waltham, MA (US)

(72) Inventors: Orlando L. Mijares, Tucson, AZ (US); Dan L. Reller, Vail, AZ (US); Sridhar Krishnamurthi Siddhamalli, Tucson, AZ (US)

(21) Appl. No.: 17/326,887

(22) Filed: May 21, 2021

Related U.S. Application Data
(60) Provisional application No. 63/133,521, filed on Jan. 4, 2021.

(51) Int. Cl. B63B 5/24; B29C 70/46

(52) U.S. Cl. CPC B63B 5/24; B29L 2031/307; B29C 70/467

(57) ABSTRACT

An underwater structure includes a half cylinder with ribs arranged on an interior surface. The half cylinder and the ribs are a semi-monocoque structure including a fiber reinforced thermoplastic composite.

### CROSS-REFERENCE TO RELATED APPLICATION

This application is a U.S. nonprovisional patent application which claims priority to U.S. Provisional Patent Application No. 63/133,521, filed Jan. 4, 2021, which is incorporated by reference herein in its entirety.

### BACKGROUND

The present disclosure relates to materials for underwater applications, and more specifically, to high performance composite materials for underwater applications.

Materials used to construct undersea capsule systems, such as for unmanned vehicles and missiles, must satisfy various criteria. The materials must be resilient against high pressures, moisture permeation/intrusion, and harsh underwater environments for long durations. The materials should also be highly reliable and need little to no maintenance. Further, the materials used to form the undersea encapsulation systems should accommodate a great diversity of payloads and low risk launch modes.

### SUMMARY

Underwater structures and methods of making thereof are disclosed. According to one or more embodiments of the present disclosure, an underwater structure includes a half cylinder with ribs arranged on an interior surface. The half cylinder and the ribs are a semi-monocoque structure with a fiber reinforced thermoplastic composite.

According to other embodiments of the present disclosure, an underwater structure includes a cylinder that is a monocoque structure with a fiber reinforced thermoplastic composite.

Yet, according to other embodiments of the present disclosure, a method of making an underwater structure includes heating and applying under pressure a fiber reinforced thermoplastic composite material to a mold such that the fibers extend continuously around or along a length of the underwater structure to form a semi-monocoque or monocoque underwater structure.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1A is a perspective view of half cylinder formed from a fiber reinforced thermoplastic composite material according to embodiments of the present disclosure;

FIG. 1B is a perspective view of a rib (stiffener) of the half cylinder of FIG. 1A according to embodiments of the present disclosure;

FIG. 2 is an exploded perspective view of an underwear capsule formed from two half cylinders according to embodiments of the present disclosure;

FIG. 3 is a flow diagram for making a semi-monocoque part from fiber reinforced thermoplastic composite materials according to embodiments of the present disclosure;

FIG. 4 is a schematic diagram of a process flow for forming rib/stiffeners from a fiber reinforced thermoplastic composite material according to embodiments of the present disclosure; and

FIG. 5 is a perspective view of a monocoque cylinder formed from a fiber reinforced thermoplastic composite material according to embodiments of the present disclosure.

### DETAILED DESCRIPTION

Current materials used to construct undersea capsule systems, such as for unmanned vehicles and missiles, include metals, such as aluminum, corrosion-resistant steel (CRES), titanium, and epoxy composites. The metals are formed as half cylinders that are subsequently fastened, bonded, or welded together to form the final capsule. Such metals have drawbacks, however. The materials are heavy, susceptible to corrosion, and highly labor intensive. Further, forming the capsules using such metals poses manufacturing challenges. For example, the half cylinders must be effectively sealed together by fastening, which requires reliance on upstream supply chains for the fasteners and/or materials. Epoxy composites used to form the undersea capsules also have various challenges. For example, the epoxy composites are not hermetic to water permeation. Further, the mechanical properties of the epoxy composites can degrade when wet.

For undersea applications, the materials much be resilient against high pressures and harsh environments with little to no maintenance. Further, the materials used to form the undersea systems should accommodate a great diversity of payloads and low risk launch modes.

Described herein are undersea systems formed from fiber reinforced thermoplastic composite materials and methods of making thereof. The undersea systems include structures that are submersed underwater, such as under the sea/ocean, for extended periods of time, for example pressure vessels, underwater hulls, and underwater capsules. The thermoplastic composite materials include, in some embodiments, polyetheretherketones (PEEK) reinforced with a continuous fiber, such as a graphite fiber, across the structure. The methods for forming the undersea structure are in-situ consolidation (ISC) processes, which fabricate a single stiffened structure without the need to secondarily bond or fasten stiffeners to the skin, as the entire stiffened structure is formed in a single processing step to form a monocoque or semi-monocoque structure.

The fiber reinforced thermoplastic composites provide undersea structures that are resistant to water permeation (e.g., 0.25% absorption versus 1% absorption for epoxy composites over the course of two years at 1020 meters depth) and provide superior (two to five times greater) damage resistance (e.g., fracture toughness) compared to epoxy composites. The composites also provide a high continuous use resin temperature compared to epoxy resins (e.g., 300° F. to 500° F. versus 225° F. for 350° F. for epoxies), which can minimize or eliminate the need for insulation (costs, weight) when used in proximity to or in contact with other system components or structures that might be hot. The monocoque composite materials also demonstrate the potential for other advantages, including for example, ˜56% weight savings, ˜10% increase in internal volume, and three years hermeticity to water for a specific application.

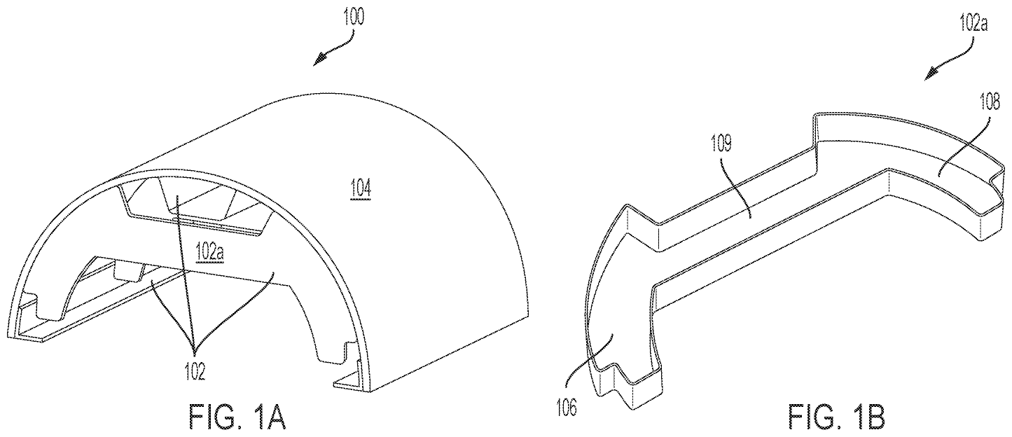

FIG. 1A is a perspective view of half cylinder 100 formed from a fiber reinforced thermoplastic composite material according to embodiments of the present disclosure. The half cylinder 100 includes a plurality of reinforcing ribs 102 (also referred to as stiffeners) that are arranged along an internal concave surface of the half cylinder curved body 104. The reinforcing ribs 102 are any shape, size, and/or dimension and function to structurally reinforce or stiffen the curved body 104. In some embodiments, the ribs 102 extend partially or fully across the circumference or even diameter of the curved body 104 from one side to the other. In other embodiments, the ribs 102 extend partially or fully along the longitudinal length of the curved body 104.

FIG. 1B is a perspective view of a rib 102a (stiffener) of the half cylinder 100 of FIG. 1A, which as described in further detail below, is fused in-situ with the curved body 104 in an in-situ consolidation process. The rib 102a includes a first arm 106 that will be adjoined to a first surface of the curved body 104 (FIG. 1A) of the stiffened half cylinder 100, a second arm 108 that will be adjoined to a second surface of the curved body 104, and a body 109 that extends between the first arm 106 and the second arm 108, which provides structural reinforcement to the curved body 104 of the half cylinder 100.

The half cylinders described herein, including the reinforcing ribs/stiffeners, are formed from a fiber reinforced thermoplastic composite material. According to some embodiments, the thermoplastic of the composite is polyetheretherketone (PEEK). Other non-limiting examples of thermoplastics for the composite material include low melting polyaryletherketone (LMPAEK), polyphenylenesulfide (PPS), polyetherimide (PEI), or any combination thereof

Non-limiting examples of the fibers of the thermoplastic composite include long, continuous carbon fibers (e.g., graphite fibers), fiberglass fibers, para-aramid (KEVLAR®) fibers, or a combination thereof. According to one or more embodiments, the fiber of the thermoplastic composite is graphite fiber. In some embodiments, the fiber reinforced thermoplastic composite is graphite fiber reinforced polyetheretherketone (PEEK). The fibers are not short fibers but are rather long continuous fibers that extend along the length, diameter (or any angle between) of the half cylinder part or rib. The fibers are present in the composite in an amount of about 40% to about 60% fibers by volume according to some embodiments. The fibers in the composite are continuous; the in-situ consolidation (ISC) process cuts the fiber to the desired length as it applies it to the part/mold. With this ISC process, the continuous fiber has a length of 4 inches to 30 feet.

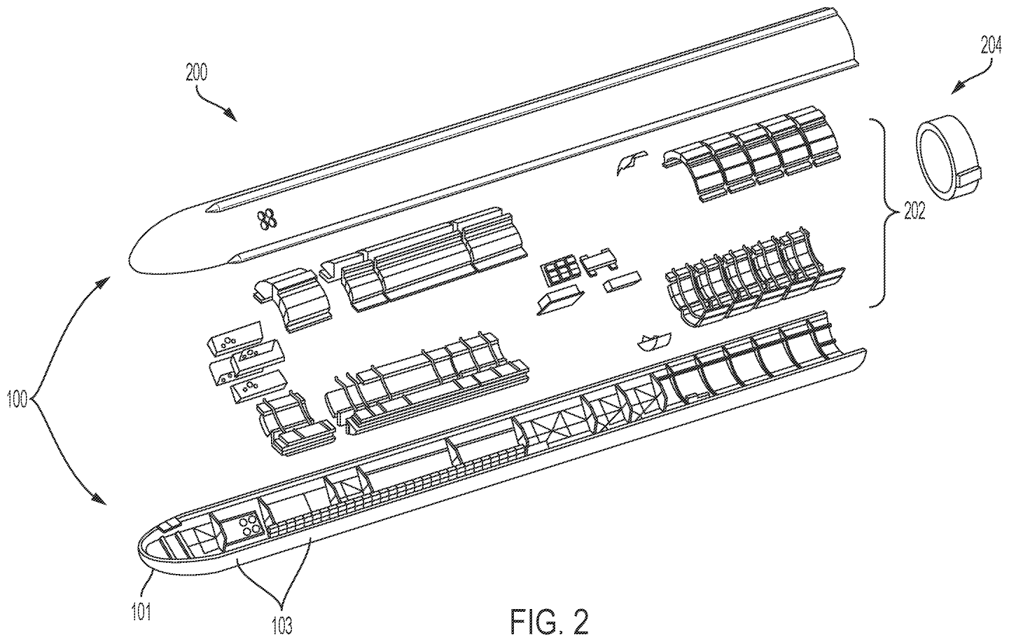

FIG. 2 is an exploded perspective view of an underwater capsule 200 formed from two half cylinders 100 according to embodiments of the present disclosure. Once separately formed, two stiffened half cylinders 100 are joined to one another by various methods, including mechanical methods, such as fasteners, or chemical methods, such as bonding, or thermal methods, such as welding or fusing, or any combination thereof. Because the half cylinders 100 are formed from thermoplastic composites, they are able self-fuse to one another by heating the materials, without the need for additional adhesives. The underwater capsule 200 houses dunnage and other support structures 202 for the encapsulated payload. An end cap 204 is arranged on an end of the two half cylinders 100 once adhered/fastened to one another to form the hollow capsule.

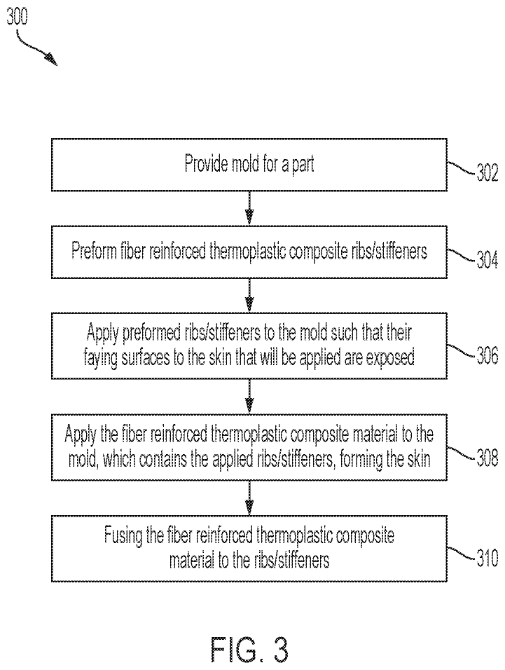

FIG. 3 is a flow diagram for forming a part, such as a stiffened half-cylinder, from a fiber reinforced thermoplastic composite material according to embodiments of the present disclosure. In box 302, a mold is provided for the part. In some embodiments, the mold includes a half cylinder with stiffeners, as shown in FIG. 1A for example, previously formed and applied (see boxes 304 and 306). The mold allows for forming the entirety of the part, including the half cylinder curved body and a plurality of interior ribs/stiffeners in a single mold.

In box 304, fiber reinforced thermoplastic composite ribs/stiffeners are preformed. In box 306, the preformed ribs/stiffeners are applied to the mold such that their faying surfaces to the skin that will be applied are exposed.

In box 308, fiber reinforced thermoplastic composite material is now applied to the mold, which contains the ribs/stiffeners, forming the skin. In box 310, as the fiber reinforced thermoplastic composite material that is applied to the mold forming the skin passes over the faying surfaces of the ribs/stiffeners, the fiber reinforced thermoplastic composite material fuses to the ribs/stiffeners. During this application process, heat is applied, for example by a laser, and pressure (by the application roller of the ISC machine) to the fiber reinforced thermoplastic composite material to form the part in an in-situ consolidation process. The skin fibers extend continuously around or along a length of the part. Because the fibers in the composite are long, they are wrapped around or extend continuously throughout the mold to add strength, rather than including short fibers dispersed throughout the material. Using in-situ consolidation takes advantage of the ability of the thermoplastic resin to melt, stick to itself (or fuse) and cool back to a solid structure. The continuous fiber can be applied to the mold in any direction as well as into or over complex contoured surfaces.

When the part is a stiffened half cylinder, the reinforcing ribs are conformed with the half cylinder shell. In other words, the part is a semi-monocoque structural component. In-situ consolidation allows formation of a stiffened structure without the need to secondarily bond or fasten the stiffeners to the outer skin. In some embodiments, the temperature used to heat the thermoplastic, such as PEEK, composite material is about 350 to about 450° C.

When the part is a stiffened half cylinder, two stiffened half cylinders are adhered to one another to form the undersea capsule. Optionally, an end cap is adhered to an end of the capsule. The two half cylinders are adhered together by fusing together with the application of heat and pressure, applying an adhesive, mechanically fastening, or any combination thereof.

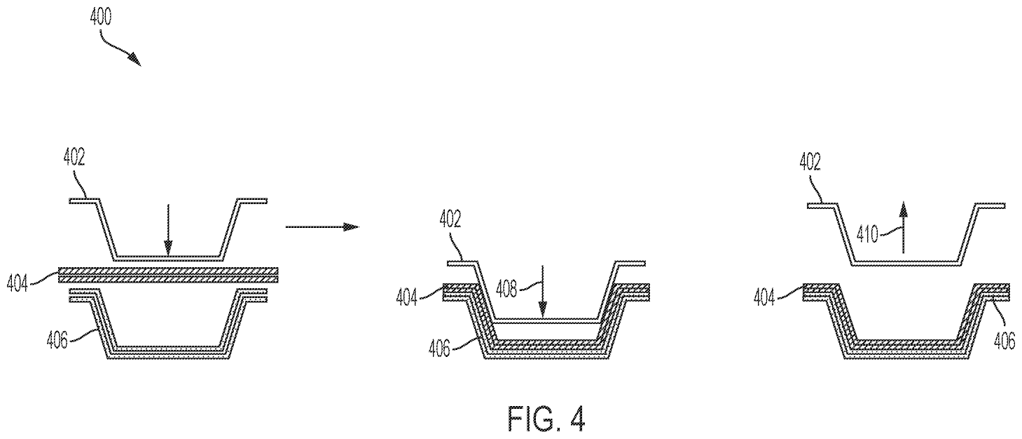

FIG. 4 is a schematic diagram of a process flow for forming a rib or stiffener from a fiber reinforced thermoplastic composite material according to embodiments of the present disclosure. After the fiber reinforced thermoplastic composite material 404 has been heated, it is pressed using pressure 408 into the cavity of a mold 406. A compression surface 402 that mirrors the shape of the mold 406 compresses the composite material 404 into the mold 406. Heat and pressure are maintained for a period of time to allow the material 404 to conform to the shape of the mold 406 and to fully consolidate. To demold after the part is formed, the part is cooled from molding temperature, compression surface 402 is removed, and the final part, now formed in the shape of the mold 406, can then be lifted away 410.

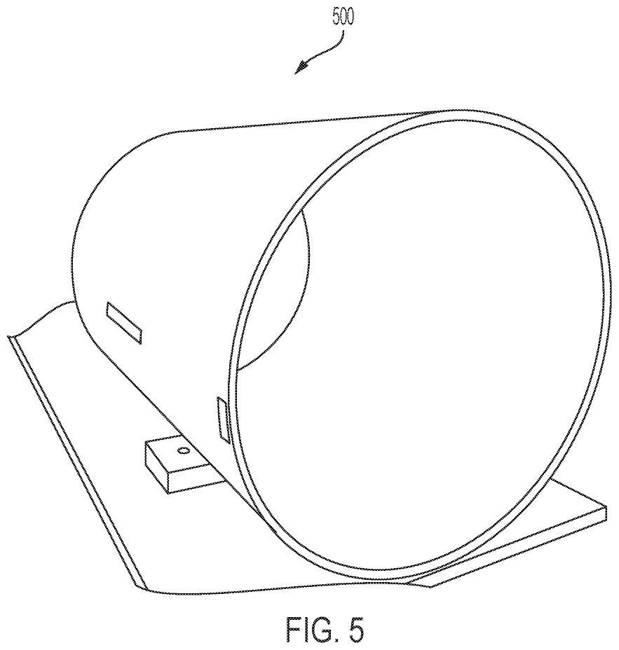

The methods described herein are used to make a part having any shape, size, or dimension, and the methods are not limited to forming a stiffened half cylinder. FIG. 5 is a perspective view of a monocoque cylinder 500 formed from a fiber reinforced thermoplastic composite material according to embodiments of the present disclosure.

The described composite materials and methods are used to fabricate affordable, high performance complex underwater structures, in additional to undersea capsules. The materials and methods also are used for offshore drilling applications in some embodiments.

Various embodiments of the present disclosure are described herein with reference to the related drawings. Alternative embodiments can be devised without departing from the scope of this disclosure. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present disclosure. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An underwater structure comprising:
a half cylinder with ribs arranged on an interior surface, the half cylinder and the ribs being a semi-monocoque structure comprising a fiber reinforced thermoplastic composite.

2. The underwater structure of claim 1, wherein the fiber reinforced thermoplastic composite includes carbon fibers, fiberglass fibers, para-aramid fibers, or a combination thereof.

3. The underwater structure of claim 1, wherein the thermoplastic composite includes continuous fibers.

4. The underwater structure of claim 3, wherein the continuous fibers are present in an amount of about 40% to about 60% by volume.

5. The underwater structure of claim 1, wherein the fiber reinforced thermoplastic composite includes low melting polyaryletherketone (LMPAEK), polyphenylenesulfide (PPS), polyetherimide (PEI), or any combination thereof.

6. The underwater structure of claim 1, wherein the fiber reinforced thermoplastic composite includes polyether ether ether ketone (PEEK).

7. The underwater structure of claim 6, wherein the fiber reinforced thermoplastic composite includes graphite fibers.

8. An underwater structure comprising:
a cylinder that is a monocoque structure comprising a fiber reinforced thermoplastic composite.

9. The underwater structure of claim 8, wherein the fiber reinforced thermoplastic composite includes carbon fibers, fiberglass fibers, para-aramid fibers, or a combination thereof.

10. The underwater structure of claim 8, wherein the fiber reinforced thermoplastic composite includes continuous fibers.

11. The underwater structure of claim 10, wherein the continuous fibers are present in an amount of about 40% to about 60% by volume.

12. The underwater structure of claim 8, wherein the fiber reinforced thermoplastic composite includes low melting polyaryletherketone (LMPAEK), polyphenylenesulfide (PPS), polyetherimide (PEI), or any combination thereof.

13. The underwater structure of claim 8, wherein the fiber reinforced thermoplastic composite includes polyether ether ether ketone (PEEK).

14. The underwater structure of claim 13, wherein the fiber reinforced thermoplastic composite includes graphite fibers.

15. A method of making an underwater structure, the method comprising:
heating and applying under pressure a fiber reinforced thermoplastic composite material to a mold, such that fibers of the fiber reinforced thermoplastic comoposite extends continuously around or along a length of the underwater structure to form a semi-monocoque or monocoque underwater structure.

16. The method of claim 15, wherein the underwater structure is a cylinder with ribs and stiffeners arranged on an interior surface.

17. The method of claim 15, wherein the fiber reinforced thermoplastic composite includes carbon fibers, fiberglass fibers, para-aramid fibers, or a combination thereof.

18. The method of claim 15, wherein the fibers are present in an amount of about 40% to about 60% by volume.

19. The method of claim 15, wherein the fiber reinforced thermoplastic composite includes low melting polyaryletherketone (LMPAEK), polyphenylenesulfide (PPS), polyetherimide (PEI), or any combination thereof

20. The method of claim 15, wherein the fiber reinforced thermoplastic composite includes polyether ether ether ketone (PEEK) and graphite fibers.
